(19) United States
(12) Patent Application Publication
(10) Pub. No.: US 2024/0429607 A1
(43) Pub. Date: Dec. 26, 2024

(54) MULTI-FREQUENCY-RANGE ANTENNAS

(71) Applicant: QUALCOMM Incorporated, San Diego, CA (US)

(72) Inventors: Jorge FABREGA SANCHEZ, San Diego, CA (US); Allen Minh-Triet TRAN, Rancho Santa Fe, CA (US)

(21) Appl. No.: 18/339,141

(22) Filed: Jun. 21, 2023

(51) Int. Cl. H01Q 5/35; H01Q 5/10

(52) U.S. Cl. CPC H01Q 5/35; H01Q 5/10

(57) ABSTRACT

A method of transducing signals over multiple frequency ranges includes: transducing between first wireless signals and first guided signals using a first antenna element, the first wireless signals and the first guided signals being in a first frequency range; transducing between second wireless signals and second guided signals using a second antenna element, the second wireless signals and the second guided signals being in a second frequency range that includes higher frequencies than the first frequency range; and inhibiting energy in the second frequency range from propagating, as a second-order mode, in the first antenna element.

### BACKGROUND

Wireless communication devices are increasingly popular and increasingly complex. For example, mobile telecommunication devices have progressed from simple phones, to smart phones with multiple communication capabilities (e.g., multiple cellular communication protocols, Wi-Fi, BLUETOOTH® and other short-range communication protocols), supercomputing processors, cameras, etc. Wireless communication devices have antennas to support various functionality such as communication over a range of frequencies, reception of Global Navigation Satellite System (GNSS) signals, also called Satellite Positioning Signals (SPS signals), etc.

With several antennas disposed in a single wireless communication device, available volume for antennas is at a premium. For example, smartphones may have numerous antennas (e.g., eight antennas, 10 antennas, or more) with very limited volume due to the size of devices that consumers desire. Consequently, antenna assemblies (e.g., modules) may be limited to very small volumes, e.g., with widths of 4 mm or less.

Despite the volume restrictions for antennas, desired functionality of the antennas continues to increase. With the advent of 5th generation (5G) of wireless communication technology, mmW (millimeter-wave) phased array antennas have received extensive attention to address the propagation loss and aperture blockage hurdles by introducing higher antenna gain and beamforming features. Multiple-input-multiple-output (MIMO) systems is one of the key enablers of 5G technology to increase the spectral efficiency and system capacity by effectively streaming the transmit/receive data with two orthogonally polarized signals (cross-polarized signals) in desired directions. The trend in consumer electronics is to develop RF assemblies (radio frequency assemblies) with small form factors which can be easily accommodated within the limited space of the emerging smart devices including cell phones and tablets. The physical requirements of antennas make maintaining or improving performance (e.g., in terms of coverage, latency, and quality of service over desired coverage area) difficult.

Forthcoming smart devices will be equipped with 5G technology and may be configured to operate over a wide range of frequencies. For example, currently allocated spectrum for 5G includes 0.41 GHz-7.125 GHz and 24.25 GHz-52.6 GHZ, including five popular bands n258 (24.25-27.5 GHZ), n261 (27.5-28.35 GHZ), n257 (26.5-29.5 GHz), n260 (37.0-40.0 GHz), and n259 (39.5-43.5 GHZ). Further, frequencies from 7.1 GHz to 24.25 GHz are receiving interest, in particular the 13 GHZ band (12.75 GHz-13.25 GHz).

### SUMMARY

An example user equipment (UE) antenna system includes: a dual-range antenna element comprising: a ground conductor; a dielectric material; a first antenna element comprising: a first patch conductor disposed in the dielectric material and configured to transduce between first wireless signals in a first frequency range and first guided signals in the first frequency range; and at least one first energy coupler disposed and configured to couple energy in the first frequency range between the first patch conductor and the at least one first energy coupler; a second antenna element comprising: a second patch conductor disposed in the dielectric material and configured to transduce between second wireless signals in a second frequency range and second guided signals in the second frequency range, the second frequency range including higher frequencies than the first frequency range; and at least one second energy coupler disposed and configured to couple energy in the second frequency range between the second patch conductor and the at least one second energy coupler; and a frequency inhibitor electrically connected to the first patch conductor and configured to inhibit energy in the second frequency range from propagating, as a second-order mode, in the first antenna element.

An example method of transducing signals over multiple frequency ranges includes: transducing between first wireless signals and first guided signals using a first antenna element, the first wireless signals and the first guided signals being in a first frequency range; transducing between second wireless signals and second guided signals using a second antenna element, the second wireless signals and the second guided signals being in a second frequency range that includes higher frequencies than the first frequency range; and inhibiting energy in the second frequency range from propagating, as a second-order mode, in the first antenna element.

Another example UE antenna system includes: means for transducing between first wireless signals and first guided signals using a first antenna element, the first wireless signals and the first guided signals being in a first frequency range; means for transducing between second wireless signals and second guided signals using a second antenna element, the second wireless signals and the second guided signals being in a second frequency range that includes higher frequencies than the first frequency range; and means for inhibiting energy in the second frequency range from propagating, as a second-order mode, in the first antenna element.

### BRIEF DESCRIPTION OF THE DRAWINGS

FIG. 1 is a schematic diagram of a communication system.

FIG. 2 is an exploded perspective view of simplified components of a mobile device shown in FIG. 1.

FIG. 3 is a block diagram of a user equipment including one or more dual-range antenna elements.

FIG. 4 is a block diagram of another user equipment including one or more dual-range antenna elements.

FIG. 5 is a perspective view of an example dual-range antenna element.

FIG. 6 is a top view of the dual-range antenna element shown in FIG. 5.

FIG. 7 is a side view of the dual-range antenna element shown in FIG. 5.

FIG. 8 is a perspective view of an antenna system of the antenna elements shown in FIG. 5.

FIG. 9 is a perspective view of an antenna system of antenna elements including antenna elements shown in FIG. 5 and single-frequency-range antenna elements of one of the frequency ranges of the antenna elements shown in FIG. 5.

FIG. 10 is a perspective view of an antenna system of antenna elements including antenna elements shown in FIG. 5, single-frequency-range antenna elements of a frequency range other than the frequency ranges of the antenna elements shown in FIG. 5, and dual-frequency-range antenna elements for one of the frequency ranges of the antenna elements shown in FIG. 5 and the frequency range of the single-frequency-range antenna elements.

FIG. 11 is block flow diagram of a method of transducing signals over multiple frequency ranges.

### DETAILED DESCRIPTION

Techniques are discussed herein for supporting multiple frequency bands in a device, e.g., millimeter-wave frequencies and sub-mm-wave frequencies (such as a 13 GHz band) in a form factor suitable for a user equipment (UE) such as a smartphone or tablet computer. For example, a dual-frequency-range antenna element may include multiple patch antenna elements, either or both of which may be dual polarized. The patch antenna elements may be configured to transduce signals in various frequencies ranges, e.g., frequency ranges related by about a factor of two or another factor, e.g., three or four, etc. For example, one patch antenna element may be configured to transduce signals in the FR3 frequency band (e.g., a frequency range including 13 GHZ, e.g., 12.75 GHz-13.25 GHZ) and the other patch antenna element configured to transduce signals in the FR2 frequency band (e.g., a frequency range including 26 GHZ, e.g., frequencies from 24.25 GHz to 29.5 GHZ). As another example, one patch antenna element may be configured to transduce signals in the FR3 frequency band and the other patch antenna element configured to transduce signals in a frequency range from about 50 GHz to about 54 GHZ). The UE may include one or more frequency inhibitors. For example, a reject filter may be coupled to the higher-frequency-range patch antenna element (e.g., to an energy coupler of the patch antenna element) and configured to reject (e.g., significantly attenuate, e.g., by 10 dB or more) frequencies of the lower-frequency-range patch antenna element. As another example, a second-order mode may be suppressed in the lower-frequency-range patch antenna element. A central portion of a patch conductor of the higher-frequency-range patch antenna element may be grounded to suppress one or more higher-order modes (e.g., the second-order mode), in the frequency range of the higher-frequency-range patch antenna element, on the patch conductor. Multiple ones of the dual-frequency-range antenna element may be used in an array of antenna elements. For example, an array may include only the dual-frequency-range antenna elements. As another example, an array may include multiple ones of the dual-frequency-range antenna element and one or more antenna elements dedicated to the higher frequency range. As another example, an array may include multiple ones of the dual-frequency-range antenna element, one or more antenna elements configured to transduce signals in the higher frequency range (of the dual-frequency-range antenna elements) and an even higher frequency range (e.g., including 40 GHZ), and one or more further antenna elements dedicated to the even higher frequency range. Other configurations, however, may be used.

Items and/or techniques described herein may provide one or more of the following capabilities, as well as other capabilities not mentioned. Millimeter-wave and sub-millimeter wave antenna elements may be provided in a common antenna array or module, saving space for providing multi-band signaling in a confined volume, e.g., of a user equipment. Power loss may be limited, e.g., by providing one or more power amplifiers for mm-wave and sub-mm-wave antenna elements in close proximity to the antenna elements. Frequency diversity may be provided, e.g., to 5G mm-wave antenna arrays or modules. Power management capabilities may be shared, e.g., between mm-wave and sub-mm-wave systems (e.g., front-end circuits). Beams of multiple frequency ranges (e.g., FR2 and FR3) may be steered over significant ranges (e.g., +/−) 30° without significant gain reduction. Other capabilities may be provided and not every implementation according to the disclosure must provide any, let alone all, of the capabilities discussed. Further, it may be possible for an effect noted above to be achieved by means other than that noted, and a noted item/technique may not necessarily yield the noted effect.

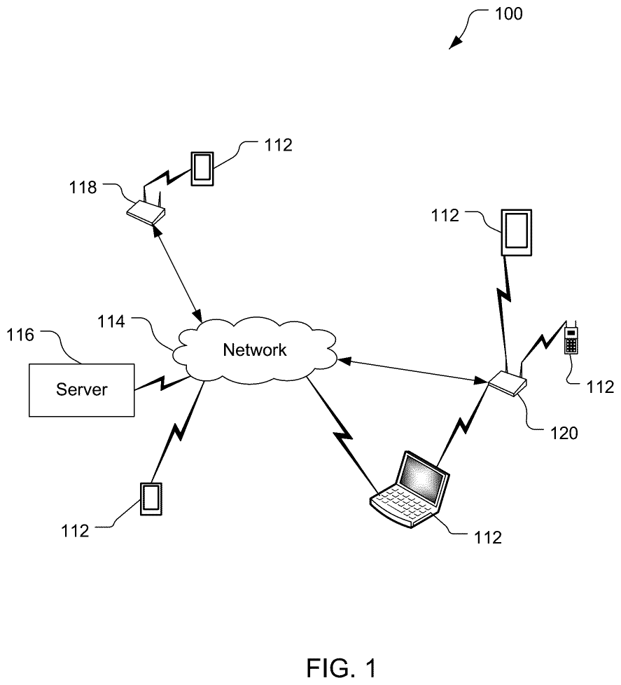

Referring to FIG. 1, a communication system 100 includes mobile devices 112, a network 114, a server 116, and access points (APs) 118, 120. The communication system 100 is a wireless communication system in that components of the communication system 100 can communicate with one another (at least sometimes) using wireless connections directly or indirectly, e.g., via the network 114 and/or one or more of the access points 118, 120 (and/or one or more other devices not shown, such as one or more base transceiver stations). For indirect communications, the communications may be altered during transmission from one entity to another, e.g., to alter header information of data packets, to change format, etc. The mobile devices 112 shown are mobile wireless communication devices (although they may communicate wirelessly and via wired connections) including mobile phones (including smartphones), a laptop computer, and a tablet computer. Still other mobile devices may be used, whether currently existing or developed in the future. Further, other wireless devices (whether mobile or not) may be implemented within the communication system 100 and may communicate with each other and/or with the mobile devices 112, network 114, server 116, and/or APs 118, 120. For example, such other devices may include internet of thing (IoT) devices, medical devices, home entertainment and/or automation devices, automotive devices, etc. The mobile devices 112 or other devices may be configured to communicate in different networks and/or for different purposes (e.g., 5G, Wi-Fi communication, multiple frequencies of Wi-Fi communication, satellite communication and/or positioning, one or more types of cellular communications (e.g., GSM (Global System for Mobiles), CDMA (Code Division Multiple Access), LTE (Long-Term Evolution), etc.), Bluetooth® communication, etc.).

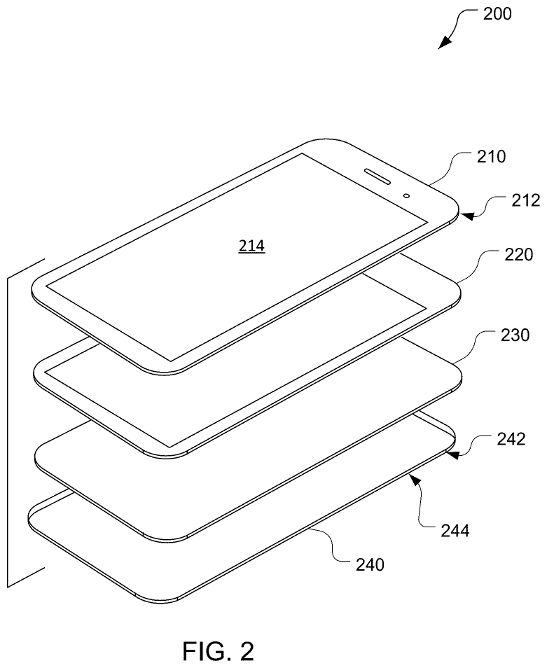

Referring to FIG. 2, a mobile device 200, which is an example of one of the mobile devices 112 shown in FIG. 1, includes a top cover 210, a display layer 220, a printed circuit board (PCB) layer 230, and a bottom cover 240. The mobile device 200 as shown may be a smartphone or a tablet computer but embodiments described herein are not limited to such devices (for example, in other implementations of concepts described herein, a device may be a router or customer premises equipment (CPE)). The top cover 210 includes a screen 214. The bottom cover 240 has a bottom surface 244. Sides 212, 242 of the top cover 210 and the bottom cover 240 provide an edge surface. The top cover 210 and the bottom cover 240 comprise a housing that retains the display layer 220, the PCB layer 230, and other components of the mobile device 200 that may or may not be on the PCB layer 230. For example, the housing may retain (e.g., hold, contain) or be integrated with antenna systems, front-end circuits, an intermediate-frequency circuit, and a processor discussed below. The housing may be substantially rectangular, having two sets of parallel edges in the illustrated embodiment, and may be configured to bend or fold. In this example, the housing has rounded corners, although the housing may be substantially rectangular with other shapes of corners, e.g., straight-angled (e.g., 45°) corners, 90°, other non-straight corners, etc. Further, the size and/or shape of the PCB layer 230 may not be commensurate with the size and/or shape of either of the top or bottom covers or otherwise with a perimeter of the device. For example, the PCB layer 230 may have a cutout to accept a battery. Further, the PCB layer 230 may include sandwiched boards and/or a PCB daughter board. Daughter boards may be chosen to facilitate a design and/or manufacturing process, e.g., to reinforce a functional separation or to better utilize a space in the housing. Embodiments of the PCB layer 230 other than those illustrated may be implemented.

The limited space available in a UE (e.g., a smartphone, tablet computer, etc.) presents antenna design challenges. For example, with 10 or more antennas for LTE and sub-6 GHZ band in a mobile phone, there may be no additional space available for another antenna. Because antenna frequency bandwidth varies with antenna size, with small antennas typically having narrow bandwidths, designing a stand-alone antenna to cover a wide frequency bandwidth is challenging. Further, mechanical stability of a UE (e.g., a mobile phone) may be challenging, e.g., because non-conductive (e.g., plastic) breaks in a metal frame of the UE may be needed to separate antennas, but may weaken stability of the frame and may result in thermal issues due to an inability to dissipate heat.

As used herein, the term “user equipment” and “UE” are not specific to or otherwise limited to any particular Radio Access Technology (RAT), unless otherwise noted. In general, UEs may be any wireless communication device (e.g., a mobile phone, router, tablet computer, laptop computer, consumer asset tracking device, Internet of Things (IoT) device, etc.) used by a user to communicate over a wireless communications network. A UE may be mobile or may (e.g., at certain times) be stationary, and may communicate with a Radio Access Network (RAN). As used herein, the term “UE” may be referred to interchangeably as an “access terminal” or “AT,” a “client device.” a “wireless device,” a “subscriber device,” a “subscriber terminal,” a “subscriber station,” a “user terminal” or UT, a “mobile terminal,” a “mobile station.” a “mobile device,” or variations thereof. Generally, UEs can communicate with a core network via a RAN, and through the core network the UEs can be connected with external networks such as the Internet and with other UEs. Of course, other mechanisms of connecting to the core network and/or the Internet are also possible for the UEs, such as over wired access networks, WiFi networks (e.g., based on IEEE (Institute of Electrical and Electronics Engineers) 802.11, etc.) and so on. Further, two or more UEs may communicate directly in some configurations with or without passing information to each other through a network.

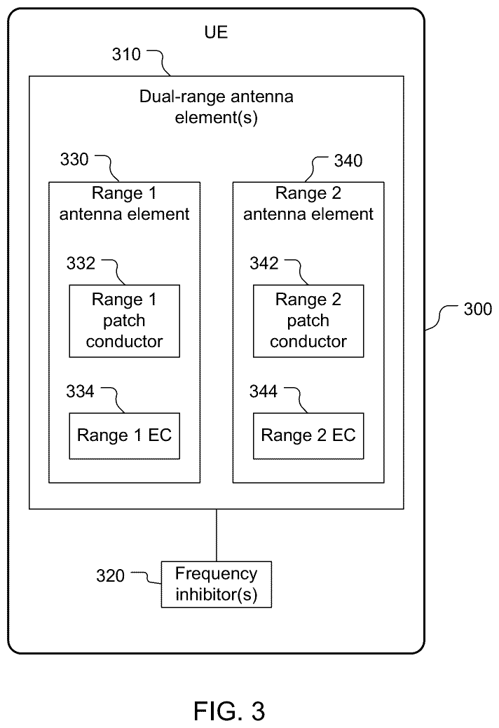

Referring also to FIG. 3, a UE 300 may include one or more dual-range antenna elements 310, and one or more frequency inhibitors 320. The UE 300 may be an example of the mobile device 200. The UE 300 is an example, and other types of apparatus may be used and/or various quantities of dual-range antenna elements may be provided in the UE 300 and/or an array may be used that includes two or more of the dual-range antenna elements 310. For example, a UE may include two or more of the antenna elements 310, e.g., disposed along different edges of the UE. As another example, an array may include two or more of the antenna elements 310 and one or more other antenna elements (which may include multiple other antenna element types, e.g., as discussed herein with respect to FIG. 9 and/or FIG. 10).

Each of the antenna element(s) 310 may include a range 1 antenna element 330 and a range 2 antenna element 340. The range 1 antenna element 330 may include a range 1 patch conductor 332 and a range 1 EC 334 (Energy Coupler). The range 2 antenna element 340 may include a range 2 patch conductor 342 and a range 2 EC 344. The range 1 patch conductor 332 may be configured to transduce between (to and/or from) first wireless signals in a first frequency range and first guided signals in the first frequency range. The first guided signals may be electrical signals (guided by an electrical conductor), optical signals (e.g., guided by a fiber optic cable), electromagnetic signals (e.g., guided by a transmission line such as a microstrip line), etc. The range 2 patch conductor 342 may be configured to transduce between (to and/or from) second wireless signals in a second frequency range and second guided signals in the second frequency range. The second frequency range (e.g., 24.25 GHZ-29.5 GHz within the FR2 band of 24.25 GHZ-52.6 GHZ) may include higher frequencies than the first frequency range (e.g., 12.75 GHZ-13.25 GHZ within the FR3 band of 7.125 GHZ-24.25 GHZ). The second frequency range may include a frequency that is twice a frequency of the first frequency range (e.g., the example second frequency range includes multiple frequencies that are each twice a respective frequency in the example first frequency range). The ECs 334, 344 may be configured to couple energy between (e.g., to and/or from) the respective EC 334, 344 and the respective patch conductor 332, 342. For example, the ECs 334, 344 may be configured to provide one or more signals to be radiated by the respective patch conductor 332, 342, and/or to receive and convey one or more signals that are received by the respective patch conductor 332, 342 to a respective front-end circuit.

The frequency inhibitor(s) 320 may be configured to inhibit one or more frequencies in the range 1 antenna element 330 and/or to inhibit one or more frequencies in the range 2 antenna element 340. For example, the frequency inhibitor(s) 320 may be configured to inhibit one or more frequencies in the range 1 antenna element 330 from coupling to the range 2 antenna element 340 and/or to inhibit one or more frequencies in the range 2 antenna element 340 from coupling to the range 1 antenna element 330.

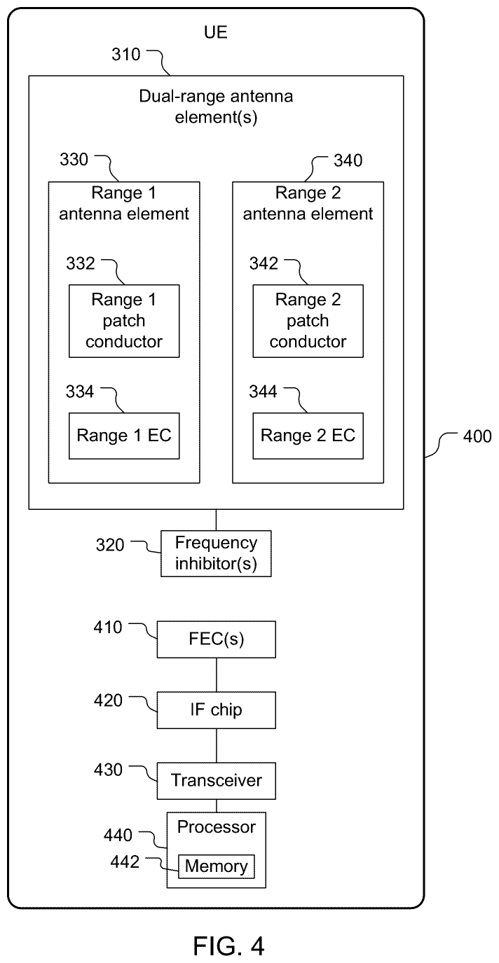

Referring also to FIG. 4, a UE 400 may include the dual-range antenna element (310), and the frequency inhibitor(s) 320, and may further include one or more FECs 410 (Front-End Circuits), an IF chip 420 (Intermediate Frequency chip), a transceiver 430, and a processor 440. The UE 400 may be an example of the mobile device 200. The UE 400 is an example, and other configurations may be used. Each of the FEC(s) 410 may be communicatively coupled to a respective energy coupler of the dual-range antenna element(s) 310. Each of the FEC(s) 410 may be configured to convert between an intermediate frequency and a respective frequency range of the respective energy coupler. The IF chip 410 may be communicatively coupled to the FEC(s) 410 and configured to convert between the IF frequency and a baseband frequency. The IF chip 420 is communicatively coupled to the transceiver 430, which is communicatively coupled to the processor 440 that includes a memory 442. In some examples, some signals may bypass the IF chip 420. For example, FR3 signals may not be converted to IF in some configurations, but may be directly converted to or from baseband in the transceiver 430 or the FEC 410. In other examples, the IF chip 420 is omitted, and all signals are directly converted between RF and baseband, for example in the FEC 410. In yet other examples, functionality of the IF chip 420 is integrated in the transceiver 420, and the transceiver 420 is configured to convert between IF and baseband. The memory 442 may be a non-transitory, processor-readable storage medium that includes software with processor-readable instructions that are configured to cause the processor 440 to perform functions (e.g., possibly after compiling the instructions). The processor 440 may be implemented as a modem or a portion thereof. The processor 440 may be configured to provide signals to be transmitted by the antenna elements and/or may process signals received by the dual-range antenna element(s) 310. The processor 440 may be configured to control operation of one or more components of the UE 400, e.g., one or more components of the FEC(s) 410. In some examples, the dual-range antenna elements 310, the frequency inhibitors 320, and the FEC(s) 410 are packaged together in a module, for example with the FEC(s) being included in an integrated circuit (IC) and the other elements being implemented in or coupled to a substrate of the module to which the IC is coupled. In other examples, the FEC(s) 410 are implemented in a separate circuit or circuits or IC or ICs, and the dual-range antenna elements 310 and the frequency inhibitors 320 are implemented in or coupled to a substrate, which may be communicatively coupled (e.g., by a cable) to the FEC(s) 410.

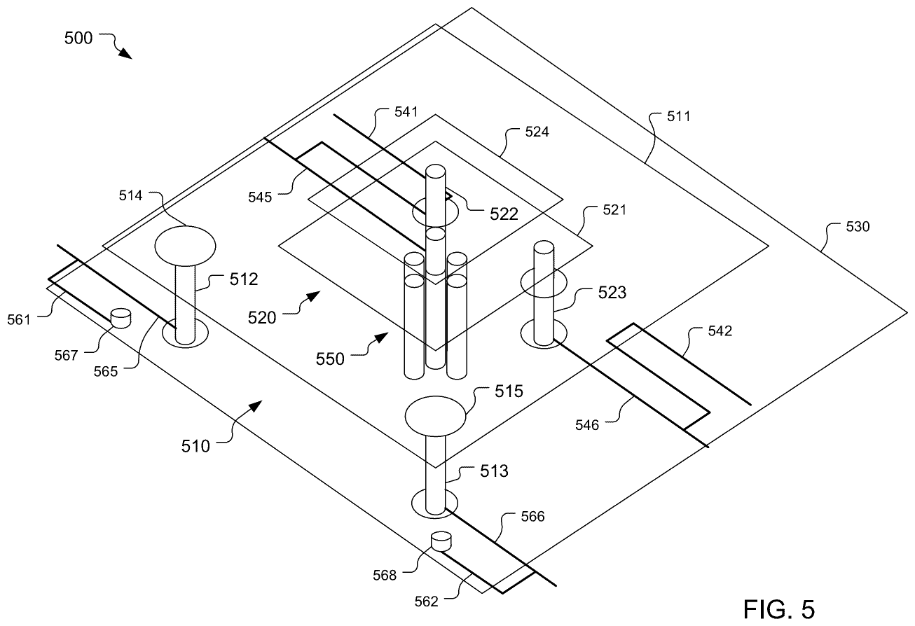

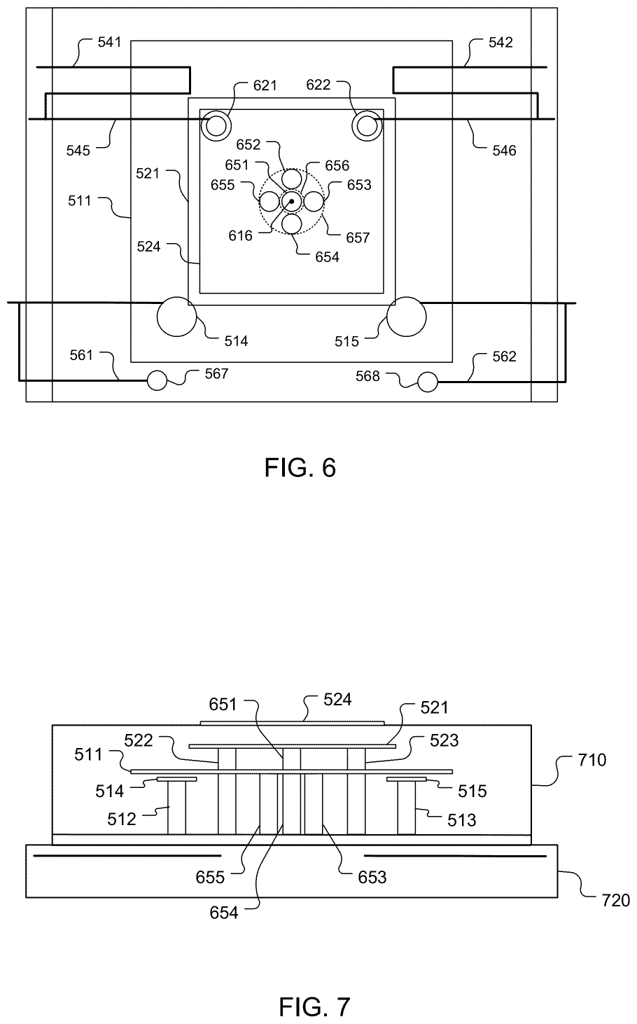

Referring also to FIGS. 5-7, a dual-range antenna element 500 is shown, which may be an example of the dual-range antenna element 310. Many items in FIGS. 5-7 are treated as being see-through for sake of clarity of the figures. The antenna element 500 includes a first antenna element 510, a second antenna element 520, a ground conductor 530, a dielectric material 710, first-frequency-range inhibitors 541, 542, a second-frequency-range inhibitor 550, and matching elements 561, 562. The first antenna element 510 includes a first patch conductor 511, and energy couplers 512, 513. The second antenna element 520 includes a second patch conductor 521, energy couplers 522, 523, and a parasitic patch conductor 524. The first antenna element 510 may be configured to transduce signals in a first frequency range and the second antenna element may be configured to transduce signals in a second frequency range that includes frequencies that are higher than frequencies in the first frequency range. The first frequency range may, for example, include a 13 GHz band (e.g., 12.75 GHZ-13.25 GHZ) and the second frequency range may, for example, include bands n258/n261/n257. Other configurations of the antenna element 500 may be used, e.g., omitting one or more of the components shown. For example, a single energy coupler may be used in the first antenna element 510 and/or a single energy coupler may be used in the second antenna element 520. As another example, the matching elements 561, 562 may be omitted, as may the first-frequency-range inhibitors 541, 542. As another example, the parasitic patch conductor 524 may be omitted. Still other configurations may be used. As another example, the first-frequency-range inhibitors 541, 542 and/or the matching elements 561, 562 may be included in/on a board on which one or more substrates each containing antenna elements (e.g., the dual-range antenna element 500) are mounted. This board may include conductive lines connected to the antenna elements, and an active component set (e.g., of an RFIC (Radio Frequency Integrated Circuit)), which may be formed in a dielectric with a different dielectric constant than the board with the antenna elements, may be mounted to the board with the antenna elements. As another example, an antenna array, e.g., as discussed further below, may be implemented in the same PCB as an active component set, e.g., with active components and antenna elements in the same dielectric material, e.g., in different layers. As shown in the example of FIG. 5, the dual-range antenna element 500 is an aperture-shared antenna element with the first antenna element 510 and the second antenna element 520 having a shared aperture, i.e., with an aperture of the first antenna element overlapping an aperture of the second antenna element 520.

The first antenna element 510 includes the first patch conductor 511 coupled to the energy couplers 512, 513 which are coupled to appropriate components of an active component set 720. The dual-range antenna element 500 and the active component set 720 may both be implemented on a single PCB or may be implemented on discrete PCBs. The first patch conductor 511 may be configured to transduce signals in the first frequency range, with the energy couplers 512, 513 being reactively coupled (here capacitively coupled) to the first patch conductor 511 by pads 514, 515 to provide dual polarization signal transducing. Here, the energy couplers 512, 513 are disposed to provide slant polarization for the first antenna element 510. In other examples, the energy couplers 512, 513 are directly connected to the first patch conductor 511.

The second antenna element 520 includes the second patch conductor 521, the energy couplers 522, 523, and the parasitic patch conductor 524. The energy couplers 522, 523 are each coupled to one or more appropriate components in the active component set 720 and are coupled to the second patch conductor 521, in this example, electrically connected to the second patch conductor 521. The energy couplers 522, 523 extend through openings 621, 622 in the first patch conductor 511 to provide some isolation between the energy couplers 522, 523 and the first patch conductor 511 (and thus between the first antenna element 510 and the second antenna element 520). The first patch conductor 511 overlaps with (here, completely overlapping) the second patch conductor 521. The first patch conductor 511 is disposed between the second patch conductor 521 and the ground conductor 530. The parasitic patch conductor 524 overlaps with and is aligned with the second patch conductor 521. The second patch conductor 521 is disposed between the first patch conductor 511 and the parasitic patch conductor 524. An active component set may include, in some examples, a mixer(s), an amplifier(s) (e.g., LNA and/or PA), and/or phase shift components.

The second-frequency-range inhibitor 550 may be configured to inhibit (e.g., suppress or prevent) one or more frequencies in the second frequency range from propagating in the first antenna element 510, e.g., from being transduced by the first patch conductor 511. For example, the second-frequency-range inhibitor 550 may be configured to inhibit a second-order mode (and/or one or more other higher-order modes) in the first patch conductor 511. In this example, the second-frequency-range inhibitor 550 includes a ground mechanism electrically connected to the ground conductor 530 and to a central portion of the first patch conductor 511 to provide a short to ground to help ensure a voltage maximum in the center of the first patch conductor 511. In this example, the ground mechanism comprises multiple (here, five) electrically-conductive grounding members, here electrically-conductive vias 651, 652, 653, 654, 655, symmetrically disposed about a center 616 of the first patch conductor and each electrically connected to the ground conductor 530 and to a central portion of the first patch conductor 511. For example, each of the vias 651-655 may be electrically connected to the first patch conductor 511 within one-tenth (or less than 1/20) of a wavelength, of a frequency in the first frequency range in the dielectric material 710, of the center 616 of the first patch conductor. For example, the vias 651-655 may each have a diameter of about 0.15 mm and a distance from the center 616 to each center of the vias 652-655 may be about 0.2 mm (e.g., 0.21 mm). Thus, a closest point of each of the via 652-655 to the center 616 may be about 0.13 mm (i.e., less than about 1/50 of a wavelength of a frequency in the first frequency range in the dielectric material 710). The vias 651-655 may, for example, be at least partially disposed within a circle 656, centered at the center 616 and with a radius of less than one-tenth (e.g., about 1/70) of a wavelength, of a frequency in the first frequency range in the dielectric material 710. As another example, the vias 651-655 may, for example, be at least partially disposed within (including fully disposed within) a circle 657, centered at the center 616 and with a radius of less than one-tenth (e.g., about 1/25) of a wavelength, of a frequency in the first frequency range in the dielectric material 710. The ground mechanism of the second-frequency-range inhibitor 550 may ground the first patch conductor 511 at least 1/25 of a wavelength, of a frequency in the first frequency range in the dielectric material 710, out from the center 616, and possibly further (e.g., 1/20, 1/15, or 1/10 of the wavelength out from the center 616). The second-frequency-range inhibitor 550 may, for example, inhibit a second-order mode in the second frequency range, e.g., at about 26 GHZ, from being emitted from the first patch conductor 511, which may help ensure a symmetrical antenna pattern for the second antenna element 520. The second-order mode may radiate toward edges of the first patch conductor 511 rather than boresight, and may induce a null at boresight in the second frequency range, e.g., at about 26 GHz.

Other configurations of the second-frequency-range inhibitor 550 may be used. For example, other quantities of vias may be used. Also or alternatively, other symmetrical configurations (e.g., layouts) of grounding members (e.g., vias) may be used such as a line of grounding members. For example, while the vias 652-655 are angularly symmetrical (angularly evenly spaced about the center 616), vias may not be angularly symmetrical but vias (e.g., the vias 652, 653) may have planar symmetry (being symmetrical about a plane transverse to the first patch conductor 511 and extending between the vias). Also or alternatively, an asymmetrical configuration of one or more grounding members may be used. For example, a single conductive via (e.g., the via 652) may be displaced from the center 616, or a set of conductive members may be used that are asymmetric about the center 616 such as two vias disposed at different distances from the center 616 and/or of different sizes (e.g., diameters) and/or shapes. Any of a variety of configurations of the second-frequency-range inhibitor 550 may be used. For example, a conductor with a larger diameter than the via 651 may be used with or without using further vias as part of the ground mechanism of the second-frequency-range inhibitor 550. As another example, additional or fewer vias may be used. For example, two or three vias (e.g., more than one) may be used, and a via aligned with the center 616 is not required. In some configurations, a single via (of standard width according to current manufacturing processes) may be insufficient to inhibit the second-order mode, while too many vias may reduce the performance of the dominant mode, e.g., by causing a short. In some examples, the vias are arranged to have reflectional symmetry (e.g., arranged in a line), and in some examples the vias are arranged to have (rotational) symmetry about center 616, which may in some configurations increase the uniformity of radiation. For example, vias may be arranged in a triangle, square, pentagon, or hexagon shape. In other examples, some vias form these shapes, and one or more vias are disposed inside of such shapes. In some examples, the outermost vias are arranged such that the portion of the via further from the center 616 is aligned with a circle (e.g., the circle 657).

The electrically-conductive via 651 may be electrically connected to the first patch conductor 511 and to the second patch conductor 521. Providing a ground connection to the center of the second patch conductor 521 with the via 651 may improve isolation and cross polarization between polarizations in the second frequency range on transmission lines 545, 546 that are connected to the energy couplers 522, 523. Connecting the via 651 to the second patch conductor 521 is optional.

The first-frequency-range inhibitors 541, 542 may be configured to (e.g., suppress or prevent) one or more frequencies in the first frequency range from propagating in (e.g., traversing) the second antenna element 520. For example, the first-frequency-range inhibitors 541, 542 may inhibit signals of one or more frequencies in the first frequency range from being conveyed from the second patch conductor 521 to the transmission lines 545, 546 (that are coupled to one or more components of the active component set 720, e.g., of respective front-end circuits) or from the transmission lines 545, 546 to the second patch conductor 521. In this example, the first-frequency-range inhibitors 541, 542 may inhibit signals of one or more frequencies in the first frequency range from being conveyed between the energy couplers 522, 523 and respective front-end circuits. In this example, the first-frequency-range inhibitors 541, 542 comprise notch filters configured to reject (e.g., attenuate) one or more frequencies in the first frequency range. In this example, each of the first-frequency-range inhibitors 541, 542 comprises an open-ended transmission line (here a microstrip line) configured to convey frequencies in the first frequency range and reject undesired frequencies (e.g., being about ¼ wavelength, in a dielectric of the active component set 720 at frequencies desired to be rejected). For example, for a dielectric constant of 3.5, to reject signals at 13 GHZ, the first-frequency-range inhibitors 541, 542 may be about 3.1 mm long. Each of the of open-ended transmission lines may have, for example, a length between 0.2λ and 0.3λ of a frequency in the first frequency range in the dielectric material of the active component set 720. The first-frequency-range inhibitors 541, 542 may be electrically connected to the transmission lines 545, 546 connected to the energy couplers 522, 523. Where the first-frequency-range inhibitors 541, 542 are connected to the transmission lines 545, 546 may be selected to improve matching, and may vary based on patch design (e.g., size, height, etc.). For example, the first-frequency-range inhibitors 541, 542 may be connected to the transmission lines 545, 546 about ⅛ of a wavelength in the dielectric of the active component set 720 from the energy couplers 522, 523, respectively. The first-frequency-range inhibitors 541, 542 may improve isolation between the transmission lines 545, 546 of the second antenna element 520 and transmission lines 565, 566 of the first antenna element 510.

The matching elements 561, 562 are electrically connected to the transmission lines 565, 566 that connect the energy couplers 512, 513 to the active component set 720 (e.g., respective font-end circuits). Each of the matching elements 561, 562 is a matching stub transmission line that is terminated in a short, e.g., an electrically-conductive via 567, 568 connected to a respective one of the matching elements 561, 562 and to the ground conductor 530. The matching elements 561, 562 may be about ⅛ of a wavelength in the dielectric of the active component set 720 and act as inductors. Where the matching elements 561, 562 are connected to the transmission lines 565, 566 may be selected to improve matching, and may vary based on design of the dual-range antenna element 500. For example, the matching elements 561, 562 may be connected to the transmission lines 565, 566 about ⅛ of a wavelength in the dielectric of the active component set 720 from the energy couplers 512, 513, respectively.

The dielectric material 710 may have a relatively high dielectric constant. For example, the dielectric material 710 may have a dielectric constant above 7.0, or above 9.0, e.g., about 9.4. A high dielectric constant may help the dual-range antenna element 500 be small, e.g., about a size of an antenna element for only the second frequency range with a low-dielectric-constant dielectric material used. This may facilitate having a spacing between adjacent ones of the dual-range antenna element 500 in an array be about a quarter wavelength (in free space) at frequencies in the first frequency range and about a half wavelength (in free space) at frequencies in the second frequency range.

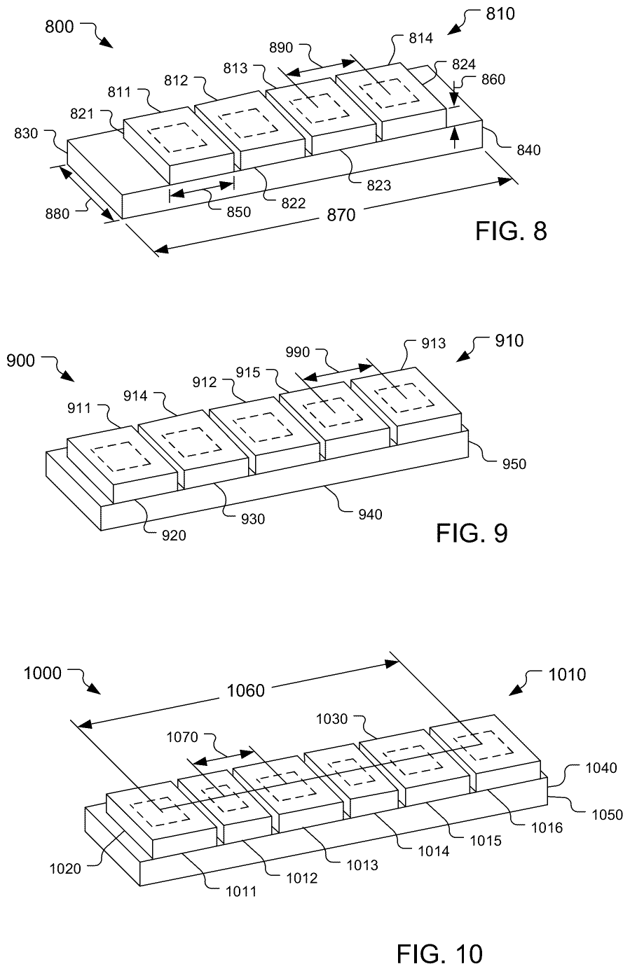

Referring also to FIG. 8, an antenna system 800 that comprises an array 810 of dual-range antenna elements 811, 812, 813, 814 is shown. In this example, each of the antenna elements 811-814 is an example of the dual-range antenna element 500. The array 810 is a 1×4 array, although arrays of other quantities of antenna elements, including other arrangements such as two-dimensional arrays (e.g., a 4×4 array) may be implemented. In this example, the antenna elements 811-814 are disposed in respective dielectric materials 821, 822, 823, 824 each with a dielectric constant of about 9.4. Alternatively, two or more of the antenna elements 811-814 may be disposed in each of one or more shared dielectric materials. A dielectric material 830 of an active component set 840 may have a lower dielectric constant, e.g., about 3.6. With the system 800 configured for operation in FR3 (around 13 GHZ) and FR2 (between about 24 GHz and 29.5 GHZ) a width 850 of each of the dielectric materials 821-824 may be about 4.2 mm, a height 860 of each of the dielectric materials 821-824 may be about 1.25 mm, a length 870 of the system 800 may be about 24.6 mm, and a width 880 of the system 800 may be about 4.2 mm. Each of the antenna elements 811-814 may be configured for dual polarization. A center-to-center spacing 890 of the array 810 (i.e., between adjacent pairs of the antenna elements 811-814) may be about 6 mm (about 0.26% at 13 GHz and about 0.52λ₀ at 26 GHz). Simulations of the antenna system 800 have shown return loss below-5 dB over 12.65 GHZ-13.25 GHZ and 24.5 GHZ-29.5 GHz, and have shown peak realized gain over 3.1 dBi over 12.75 GHZ-13.25 GHZ, and over 8.4 dBi over 24.25 GHZ-29.5 GHZ. The active component set 840 may be implemented in a PCB that is distinct from (although electrically, and possibly physically, connected to) a PCB in which the array 810 is implemented. While the array 810 and active component set 840 are shown as being vertically stacked, in other configurations the array 810 and active component set 840 may be disposed laterally next to each other or remote from one another (and, e.g., coupled by a cable or conductor). Other configurations may be used, e.g., with the array 810 and the active component set 840 being part of a single PCB.

One or more of the antenna elements 811-814 may be selectively turned ON or OFF (e.g., by the processor 440), and/or one or more of the antenna elements within one or more the antenna elements 811-814 may be selectively turned ON or OFF (e.g., by the processor 440). For example, a lower-frequency-range antenna element within every other one of the antenna elements 811-814 (e.g., the antenna element 812 and the antenna element 814) may be turned OFF such that an inter-element spacing between adjacent ones of the lower-range antenna elements that are turned ON may be close to one-half of a wavelength in free space of a frequency within the lower frequency range. Turning one or more antenna elements OFF may improve isolation during concurrent transmission between antenna elements configured for different frequency ranges. As another alternative, every other one of the antenna elements 811-814 (e.g., the antenna elements 812, 814) may be configured with only higher-frequency-range antenna elements and the other antenna elements (e.g., the antenna elements 811, 813) may each be configured with both a higher-frequency-range antenna element and a lower-frequency-range antenna element.

The antenna system 800 (and/or one or more other antenna systems, e.g., as discussed with respect to FIG. 9 and/or FIG. 10) may have any of a variety of configurations. For example, the active component set 840 may be disposed in an RFIC and the array 810 may be packaged with the RFIC in a module. As another example, the active component set 840 may be disposed in an RFIC and the array 810 may be communicatively coupled to the RFIC by one or more transmission lines (e.g., one or more microstrip lines, and/or one or more coaxial cables, and/or one or more other forms of transmission line).

Referring also to FIG. 9, an antenna system 900 includes an array 910 of antenna elements 911, 912, 913, 914, 915. In this example, each of the antenna elements 911-913 is a dual-range antenna element that is an example of the dual-range antenna element 500. The antenna elements 914, 915 in this example are single-range antenna elements configured for operation in the second frequency range (higher-frequency frequency range) of the dual-range antenna element 500. The array 910 is a 1×5 array with interleaved dual-range and single-range antenna elements, with each of the antenna elements 914, 915 between adjacent ones of the antenna elements 911-913. Other array configurations may be implemented, e.g., with other quantities of antenna elements, or other arrangements such as two-dimensional arrays may be implemented. In this example, each of the antenna elements 911-913 is disposed in a dielectric material 920 with a dielectric constant of about 9.4 (e.g., an LTCC (Low-Temperature Cofired Ceramic) or mSAP (Modified Semi Additive Process) material). Also in this example, each of the antenna elements 914, 915 is disposed in a dielectric material 930 with a lower dielectric constant, e.g., about 3.6, which may help improve bandwidth in the second frequency range compared with elements configured for the second frequency range within a higher-dielectric-constant dielectric material. A dielectric material 940 of an active component set 950 may have a dielectric constant similar to that of the dielectric material 930, e.g., about 3.6. With the system 900 configured for operation in FR3 (around 13 GHZ) and FR2 (between about 24 GHz and 29.5 GHZ), a width of each of the dielectric materials for the antenna elements 911-915 may be about 4.2 mm, a height of each of the dielectric materials for the antenna elements 911-915 may be about 1.25 mm, a length of the system 900 may be about 24.6 mm, and a width of the system 900 may be about 4.2 mm. Each of the antenna elements 911-915 may be configured for dual polarization. A center-to-center spacing 990 of the array 910 (i.e., between adjacent pairs of the antenna elements 911-915) may be about one-half of a wavelength for each frequency range used, e.g., between 0.35 wavelengths and 0.65 wavelengths (such as between 0.4 and 0.5 waveleneghts). For example, the center-to-center spacing 990 may be about 9.4 mm, resulting in about 0.412% at 13 GHZ between the elements 911, 912 and between the elements 912, 913, and about 0.42% at 26 GHZ between adjacent pairs of the antenna elements 911-915. Simulations of the antenna system 900 have shown return loss below about-5 dB over 12.65 GHZ-13.25 GHZ and 24.5 GHZ-29.5 GHZ, and have shown peak realized gain over 3.1 dBi over 12.75 GHZ-13.25 GHz, and over 8.4 dBi over 24.25 GHZ-29.5 GHZ.

Referring also to FIG. 10, an antenna system 1000 includes an array 1010 of antenna elements 1011, 1012, 1013, 1014, 1015, 1016. The antenna system 1000 may be configured to operate in three different frequency ranges, e.g., in a first frequency range (e.g., around 13 GHZ (e.g., 12.75 GHZ-13.25 GHZ)), a second frequency range having higher frequencies than the first frequency range (e.g., about 24.5 GHZ to about 29.5 GHZ), and a third frequency range having higher frequencies than the second frequency range (e.g., around 40 GHZ (e.g., about 37.0 GHz to about 43.5 GHZ)). In this example, each of the antenna elements 1011, 1016 is a dual-range antenna element that is an example of the dual-range antenna element 500. Each of the antenna elements 1012, 1014 in this example is a single-range antenna element configured for operation in the third frequency range. Other examples may include another single-range antenna element disposed between 1015 and 1016. Each of the antenna elements 1013, 1015 in the illustrated example is a dual-range antenna element configured for operation in the second frequency range and the third frequency range. In this example, each of the antenna elements 1011, 1016 is disposed in a dielectric material 1020 with a dielectric constant of about 9.4. Also in this example, each of the antenna elements 1012-1015 is disposed in a dielectric material 1030 with a lower dielectric constant, e.g., about 3.6. A dielectric material 1040 of an active component set 1050 may have a dielectric constant similar to that of the dielectric material 1030, e.g., about 3.6. With the system 1000 configured for operation around 13 GHZ, between about 24 GHZ and 29.5 GHZ, and between about 37.0 GHZ and about 43.5 GHZ, a height of each of the dielectric materials for the antenna elements 1011-1016 may be about 1.25 mm, a length of the system 1000 may be about 23.9 mm, and a width of the system 1000 may be about 4.2 mm. Each of the antenna elements 1011-1016 may be configured for dual polarization. A center-to-center spacing 1060 of an adjacent pair of first-frequency-range antenna elements, here the antenna elements 1011, 1016, may be about 18.4 mm (about 0.78% at 13 GHZ). Center-to-center spacings between adjacent pairs of second-frequency-range antenna elements, here between the antenna elements 1011, 1013, between the antenna elements 1013, 1015, and between the antenna elements 1015, 1016 may vary from about 4.9 mm to about 6.9 mm (about 0.42λ₀ to about 0.6λ₀ at 26 GHZ). A center-to-center spacing 1070 between adjacent pairs of third-frequency-range antenna elements, here the antenna elements 1012, 1013, the antenna elements 1013, 1014, and the antenna elements 1014, 1015, may be about 3.2 mm (about 0.44λ₀ at 40 GHz). Simulations of the antenna system 1000 have shown return loss below about-5.2 dB over 12.75 GHz-13.25 GHz, below about-5.5 dB over 24.5 GHZ-29.5 GHZ, and below about 10.6 dB over 37.0 GHz-43.5 GHZ, and have shown peak realized gain over about 0.2 dBi over 12.75 GHz-13.25 GHz, over about 7.9 dBi over 24.25 GHz-29.5 GHz, and over about 8.9 dBi over 37.0 GHz-43.5 GHz. Simulations have also shown +/−30° beam steering with less than 1 dB variation in gain.

The array 1010 is a 1×6 array with interleaved dual-range and single-range antenna elements, although arrays of other quantities of antenna elements, including other arrangements such as two-dimensional arrays may be implemented. In this example, a pair of the dual-range antenna elements for the second and third frequency ranges, here the antenna elements 1013, 1015, and a pair of the single-range antenna elements for the third frequency range, here the antenna elements 1012, 1014, are disposed between an adjacent pair of the dual-range antenna elements for the first and second frequency ranges, here the antenna elements 1011, 1016. The antenna elements 1011, 1016 are adjacent in that there are no other similarly-configured antenna elements between the antenna elements 1011, 1016. A pair of the dual-range antenna elements for the second and third frequency ranges, here the antenna elements 1013, 1015, are interleaved with a pair of the single-range antenna elements for the third frequency range, here the antenna elements 1012, 1014.

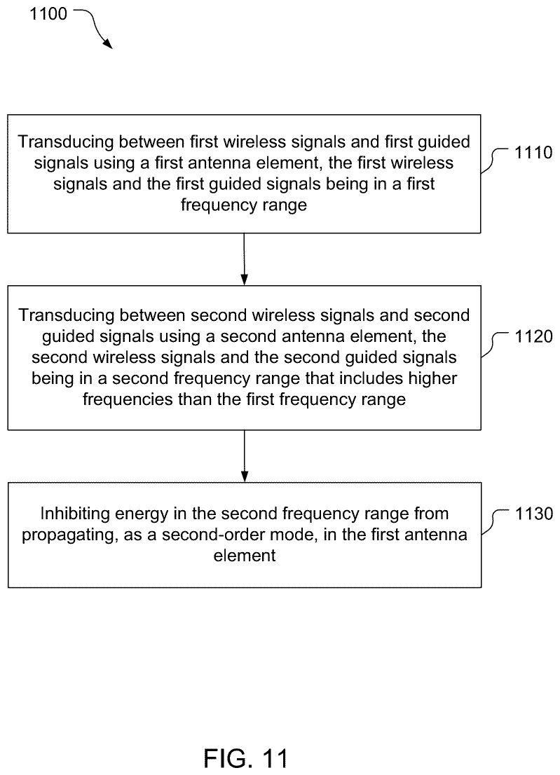

Referring to FIG. 11, with further reference to FIGS. 1-10, a method 1100 of transducing signals over multiple frequency ranges includes the stages shown. The method 1100 is, however, an example and not limiting. The method 1100 may be altered, e.g., by having one or more stages added, removed, rearranged, combined, performed concurrently, and/or having one or more single stages split into multiple stages.

At stage 1110, the method 1100 includes transducing between first wireless signals and first guided signals using a first antenna element, the first wireless signals and the first guided signals being in a first frequency range. For example, the range 1 patch conductor 332 (e.g., the first patch conductor 511) may transduce signals in a first frequency range (e.g., around 13 GHZ) between wireless and guided signals (e.g., into and/or from the range 1 energy coupler 334 (e.g., the energy coupler(s) 512, 513)). The first patch conductor 511 and the energy coupler(s) 512, 513 may comprise means for transducing between first wireless signals and first guided signals.

At stage 1120, the method 1100 includes transducing between second wireless signals and second guided signals using a second antenna element, the second wireless signals and the second guided signals being in a second frequency range that includes higher frequencies than the first frequency range. For example, the range 2 patch conductor 342 (e.g., the second patch conductor 521, and possibly the parasitic patch conductor 524) may transduce signals in a second frequency range (e.g., around 24.25-29.5 GHZ) between wireless and guided signals (e.g., into and/or from the range 2 energy coupler 344 (e.g., the energy coupler(s) 522, 523)). The second patch conductor 521 and the energy coupler(s) 522, 523 may comprise means for transducing between second wireless signals and second guided signals.

At stage 1130, the method 1100 includes inhibiting energy in the second frequency range from propagating, as a second-order mode, in the first antenna element. For example, the frequency inhibitor(s) 320 may inhibit energy in the second frequency range from propagating in the range 1 antenna element 330. For example, the second-frequency-range inhibitor 550 may inhibit a second-order mode in the first patch conductor 511, and thus inhibit the first patch conductor from transducing energy in the second frequency range, e.g., transmitting wireless signals in the second frequency range and/or transducing signals in the second frequency range into guided signals in the energy couplers 512, 513. The second-frequency-range inhibitor 550 may comprise means for inhibiting energy in the second frequency range from traversing the first antenna element.

Implementations of the method 1100 may include one or more of the following features. In an example implementation, the inhibiting comprises grounding a region within one-tenth of a wavelength, of a frequency in the first frequency range in a dielectric material in which the patch conductor is disposed, of a center of the patch conductor. For example, a grounding mechanism such as one or more electrical conductors such as the electrically-conductive vias 651-655 may ground a central portion of the first patch conductor 511 to inhibit a second-order mode from developing in the first patch conductor 511. The electrically-conductive vias 651-655 in combination with the ground conductor 530 may comprise means for grounding a region of the center of the patch conductor. In another example implementation, the method 1100 further comprises inhibiting energy in the first frequency range from propagating in the second antenna element by applying a notch filter to an energy coupler of the second antenna element to suppress frequencies in the first frequency range. For example, the frequency inhibitor(s) 320 may inhibit energy in the first frequency range from propagating in the range 2 antenna element 340. For example, the first-frequency-range inhibitors 541, 542 may inhibit energy in the first frequency range from passing between respective front-end circuits connected to the transmission lines 541, 542 and the energy couplers 522, 523, and thus inhibit energy in the first frequency range from traversing the second antenna element 520 (e.g., from propagating from respective front-end circuits to the second patch conductor 521 and/or from propagating from the second patch conductor 521 to the respective front-end circuits). The first-frequency-range inhibitors 541, 542 may comprise means for inhibiting energy in the first frequency range from propagating in the second antenna element. The first-frequency-range inhibitors 541, 542 may provide notch filters to inhibit energy in the first frequency band from propagating in the second antenna element 520. In another example implementation, the second frequency range includes a frequency that is twice a frequency of the first frequency range.

### Implementation Examples

Implementation examples are provided in the following numbered clauses.

Clause 1. A user equipment (UE) antenna system comprising:
a dual-range antenna element comprising:
a ground conductor;
a dielectric material;
a first antenna element comprising:
   a first patch conductor disposed in the dielectric material and configured to transduce between first wireless signals in a first frequency range and first guided signals in the first frequency range; and
   at least one first energy coupler disposed and configured to couple energy in the first frequency range between the first patch conductor and the at least one first energy coupler;
a second antenna element comprising:
   a second patch conductor disposed in the dielectric material and configured to transduce between second wireless signals in a second frequency range and second guided signals in the second frequency range, the second frequency range including higher frequencies than the first frequency range; and
   at least one second energy coupler disposed and configured to couple energy in the second frequency range between the second patch conductor and the at least one second energy coupler; and
a frequency inhibitor electrically connected to the first patch conductor and configured to inhibit energy in the second frequency range from propagating, as a second-order mode, in the first antenna element.

Clause 2. The UE antenna system of claim 1, wherein the frequency inhibitor comprises a ground mechanism electrically connected to the ground conductor and to the first patch conductor within one-tenth of a wavelength, of a frequency in the first frequency range in the dielectric material, of a center of the first patch conductor.

Clause 3. The UE antenna system of claim 2, wherein the ground mechanism comprises a plurality of electrically-conductive vias each electrically connected to the ground conductor and each electrically coupled to the first patch conductor within one-tenth of the wavelength, of the frequency in the first frequency range in the dielectric material, of the center of the first patch conductor.

Clause 4. The UE antenna system of any of claims 1-3, wherein the frequency inhibitor comprises a plurality of electrically-conductive vias each electrically connected to the ground conductor and each electrically coupled to the first patch conductor, the electrically-conductive vias being disposed with angular symmetry about a center of the first patch conductor.

Clause 5. The UE antenna system of any of claims 1-4, wherein the frequency inhibitor is a second frequency inhibitor, and wherein the UE antenna system further comprises a first frequency inhibitor comprising at least one notch filter, with each of the at least one notch filter being coupled to a respective one of the at least one second energy coupler and configured to suppress frequencies in the first frequency range.

Clause 6. The UE antenna system of claim 5, wherein each of the at least one notch filter comprises an open-ended transmission line electrically connected to the respective one of the at least one second energy coupler.

Clause 7. The UE antenna system of claim 6, wherein the open-ended transmission line of each of the at least one notch filter has a length of between 0.2 wavelengths, in the dielectric material, of a frequency in the first frequency range and 0.3 wavelengths, in the dielectric material, of the frequency of the first frequency range.

Clause 8. The UE antenna system of any of claims 1-7, wherein the second frequency range includes a frequency that is twice a frequency of the first frequency range.

Clause 9. The UE antenna system of any of claims 1-8, wherein the first patch conductor is disposed between the second patch conductor and the ground conductor.

Clause 10. The UE antenna system of any of claims 1-9, further comprising at least one matching stub each comprising a transmission line electrically connected to a respective one of the at least one first energy coupler and electrically connected to a ground member that is electrically connected to the ground conductor.

Clause 11. The UE antenna system of any of claims 1-10, wherein the dual-range antenna element is one of a plurality of dual-range antenna elements disposed in a linear array, the UE antenna system further comprising a third antenna element disposed between adjacent ones of the plurality of dual-range antenna elements and configured to transduce signals in the second frequency range.

Clause 12. The UE antenna system of any of claims 1-11, wherein the dual-range antenna element is one of a plurality of first dual-range antenna elements, the UE antenna system further comprising:
a plurality of second dual-range antenna elements configured to transduce signals in the second frequency range and a third frequency range that includes frequencies higher than the second frequency range; and
a plurality of third antenna elements configured to transduce signals in the third frequency range;
wherein the plurality of first dual-range antenna elements, the plurality of second dual-range antenna elements, and the plurality of third antenna elements are disposed in a linear array;
wherein a pair of the plurality of second dual-range antenna elements and a pair of the plurality of third antenna elements are disposed between each pair of adjacent ones of the plurality of first antenna elements, with the pair of the plurality of second dual-range antenna elements and the pair of the plurality of third antenna elements being interleaved.

Clause 13. A method of transducing signals over multiple frequency ranges, the method comprising:
transducing between first wireless signals and first guided signals using a first antenna element, the first wireless signals and the first guided signals being in a first frequency range;
transducing between second wireless signals and second guided signals using a second antenna element, the second wireless signals and the second guided signals being in a second frequency range that includes higher frequencies than the first frequency range; and
inhibiting energy in the second frequency range from propagating, as a second-order mode, in the first antenna element.

Clause 14. The method of claim 13, wherein the inhibiting comprises grounding a region within one-tenth of a wavelength, of a frequency in the first frequency range in a dielectric material in which the patch conductor is disposed, of a center of the patch conductor.

Clause 15. The method of claim 13 or claim 14, further comprising inhibiting energy in the first frequency range from propagating in the second antenna element by applying a notch filter to an energy coupler of the second antenna element to suppress frequencies in the first frequency range.

Clause 16. The method of any of claims 13-15, wherein the second frequency range includes a frequency that is twice a frequency of the first frequency range.

Clause 17. A user equipment (UE) antenna system comprising:
means for transducing between first wireless signals and first guided signals using a first antenna element, the first wireless signals and the first guided signals being in a first frequency range;
means for transducing between second wireless signals and second guided signals using a second antenna element, the second wireless signals and the second guided signals being in a second frequency range that includes higher frequencies than the first frequency range; and
means for inhibiting energy in the second frequency range from propagating, as a second-order mode, in the first antenna element.

Clause 18. The UE of claim 17, wherein the means for inhibiting comprise means for grounding a region within one-tenth of a wavelength, of a frequency in the first frequency range in a dielectric material in which the patch conductor is disposed, of a center of the patch conductor.

Clause 19. The UE of claim 17 or claim 18, further comprising means for filtering energy in an energy coupler of the second antenna element to suppress frequencies in the first frequency range.

Clause 20. The UE of any of claims 17-19, wherein the second frequency range includes a frequency that is twice a frequency of the first frequency range.

### Other Considerations

Other examples and implementations are within the scope of the disclosure and appended claims. For example, configurations other than those shown may be used. Also, due to the nature of software and computers, functions described above can be implemented using software executed by a processor, hardware, firmware, hardwiring, or a combination of any of these. Features implementing functions may also be physically located at various positions, including being distributed such that portions of functions are implemented at different physical locations.

As used herein, the singular forms “a,” “an,” and “the” include the plural forms as well, unless the context clearly indicates otherwise. Thus, reference to a device in the singular (e.g., “a device,” “the device”), including in the claims, includes one or more of such devices (e.g., “a processor” includes one or more processors, “the processor” includes one or more processors, “a memory” includes one or more memories, “the memory” includes one or more memories, etc.). The terms “comprises,” “comprising,” “includes,” and/or “including,” as used herein, specify the presence of stated features, integers, steps, operations, elements, and/or components, but do not preclude the presence or addition of one or more other features, integers, steps, operations, elements, components, and/or groups thereof.

Also, as used herein, “or” as used in a list of items (possibly prefaced by “at least one of” or prefaced by “one or more of”) indicates a disjunctive list such that, for example, a list of “at least one of A, B, or C,” or a list of “one or more of A, B, or C” or a list of “A or B or C” means A, or B, or C, or AB (A and B), or AC (A and C), or BC (B and C), or ABC (i.e., A and B and C), or combinations with more than one feature (e.g., AA, AAB, ABBC, etc.). Thus, a recitation that an item, e.g., a processor, is configured to perform a function regarding at least one of A or B, or a recitation that an item is configured to perform a function A or a function B, means that the item may be configured to perform the function regarding A, or may be configured to perform the function regarding B, or may be configured to perform the function regarding A and B. For example, a phrase of “a processor configured to measure at least one of A or B” or “a processor configured to measure A or measure B” means that the processor may be configured to measure A (and may or may not be configured to measure B), or may be configured to measure B (and may or may not be configured to measure A), or may be configured to measure A and measure B (and may be configured to select which, or both, of A and B to measure). Similarly, a recitation of a means for measuring at least one of A or B includes means for measuring A (which may or may not be able to measure B), or means for measuring B (and may or may not be configured to measure A), or means for measuring A and B (which may be able to select which, or both, of A and B to measure). As another example, a recitation that an item, e.g., a processor, is configured to at least one of perform function X or perform function Y means that the item may be configured to perform the function X, or may be configured to perform the function Y, or may be configured to perform the function X and to perform the function Y. For example, a phrase of “a processor configured to at least one of measure X or measure Y” means that the processor may be configured to measure X (and may or may not be configured to measure Y), or may be configured to measure Y (and may or may not be configured to measure X), or may be configured to measure X and to measure Y (and may be configured to select which, or both, of X and Y to measure).

As used herein, unless otherwise stated, a statement that a function or operation is “based on” an item or condition means that the function or operation is based on the stated item or condition and may be based on one or more items and/or conditions in addition to the stated item or condition.

Substantial variations may be made in accordance with specific requirements. For example, customized hardware might also be used, and/or particular elements might be implemented in hardware, software (including portable software, such as applets, etc.) executed by a processor, or both. Further, connection to other computing devices such as network input/output devices may be employed. Components, functional or otherwise, shown in the figures and/or discussed herein as being connected or communicating with each other are communicatively coupled unless otherwise noted. That is, they may be directly or indirectly connected to enable communication between them.

The systems and devices discussed above are examples. Various configurations may omit, substitute, or add various procedures or components as appropriate. For instance, features described with respect to certain configurations may be combined in various other configurations. Different aspects and elements of the configurations may be combined in a similar manner. Also, technology evolves and, thus, many of the elements are examples and do not limit the scope of the disclosure or claims.

A wireless communication system is one in which communications are conveyed wirelessly, i.e., by electromagnetic and/or acoustic waves propagating through atmospheric space rather than through a wire or other physical connection, between wireless communication devices (also called wireless communications devices). A wireless communication system (also called a wireless communications system, a wireless communication network, or a wireless communications network) may not have all communications transmitted wirelessly, but is configured to have at least some communications transmitted wirelessly. Further, the term “wireless communication device,” or similar term, does not require that the functionality of the device is exclusively, or even primarily, for communication, or that communication using the wireless communication device is exclusively, or even primarily, wireless, or that the device be a mobile device, but indicates that the device includes wireless communication capability (one-way or two-way), e.g., includes at least one radio (each radio being part of a transmitter, receiver, or transceiver) for wireless communication.

Specific details are given in the description herein to provide a thorough understanding of example configurations (including implementations). However, configurations may be practiced without these specific details. For example, well-known circuits, processes, algorithms, structures, and techniques have been shown without unnecessary detail in order to avoid obscuring the configurations. The description herein provides example configurations, and does not limit the scope, applicability, or configurations of the claims. Rather, the preceding description of the configurations provides a description for implementing described techniques. Various changes may be made in the function and arrangement of elements.

The terms “processor-readable medium,” “machine-readable medium,” and “computer-readable medium,” as used herein, refer to any medium that participates in providing data that causes a machine to operate in a specific fashion. Using a computing platform, various processor-readable media might be involved in providing instructions/code to processor(s) for execution and/or might be used to store and/or carry such instructions/code (e.g., as signals). In many implementations, a processor-readable medium is a physical and/or tangible storage medium. Such a medium may take many forms, including but not limited to, non-volatile media and volatile media. Non-volatile media include, for example, optical and/or magnetic disks. Volatile media include, without limitation, dynamic memory.

Having described several example configurations, various modifications, alternative constructions, and equivalents may be used. For example, the above elements may be components of a larger system, wherein other rules may take precedence over or otherwise modify the application of the disclosure. Also, a number of operations may be undertaken before, during, or after the above elements are considered. Accordingly, the above description does not bound the scope of the claims.

Unless otherwise indicated, “about” and/or “approximately” as used herein when referring to a measurable value such as an amount, a temporal duration, and the like, encompasses variations of ±20% or ±10%, ±5%, or ±0.1% from the specified value, as appropriate in the context of the systems, devices, circuits, methods, and other implementations described herein. Unless otherwise indicated, “substantially” as used herein when referring to a measurable value such as an amount, a temporal duration, a physical attribute (such as frequency), and the like, also encompasses variations of ±20% or ±10%, ±5%, or ±0.1% from the specified value, as appropriate in the context of the systems, devices, circuits, methods, and other implementations described herein.

A statement that a value exceeds (or is more than or above) a first threshold value is equivalent to a statement that the value meets or exceeds a second threshold value that is slightly greater than the first threshold value, e.g., the second threshold value being one value higher than the first threshold value in the resolution of a computing system. A statement that a value is less than (or is within or below) a first threshold value is equivalent to a statement that the value is less than or equal to a second threshold value that is slightly lower than the first threshold value. e.g., the second threshold value being one value lower than the first threshold value in the resolution of a computing system.

1. A user equipment (UE) antenna system comprising:
a dual-range antenna element comprising:
a ground conductor;
a dielectric material;
a first antenna element comprising:
a first patch conductor disposed in the dielectric material and configured to transduce between first wireless signals in a first frequency range and first guided signals in the first frequency range; and
at least one first energy coupler disposed and configured to couple energy in the first frequency range between the first patch conductor and the at least one first energy coupler;
a second antenna element comprising:
a second patch conductor disposed in the dielectric material and configured to transduce between second wireless signals in a second frequency range and second guided signals in the second frequency range, the second frequency range including higher frequencies than the first frequency range; and
at least one second energy coupler disposed and configured to couple energy in the second frequency range between the second patch conductor and the at least one second energy coupler; and
a frequency inhibitor electrically connected to the first patch conductor and configured to inhibit energy in the second frequency range from propagating, as a second-order mode, in the first antenna element.

2. The UE antenna system of claim 1, wherein the frequency inhibitor comprises a ground mechanism electrically connected to the ground conductor and to the first patch conductor within one-tenth of a wavelength, of a frequency in the first frequency range in the dielectric material, of a center of the first patch conductor.

3. The UE antenna system of claim 2, wherein the ground mechanism comprises a plurality of electrically-conductive vias each electrically connected to the ground conductor and each electrically coupled to the first patch conductor within one-tenth of the wavelength, of the frequency in the first frequency range in the dielectric material, of the center of the first patch conductor.

4. The UE antenna system of claim 1, wherein the frequency inhibitor comprises a plurality of electrically-conductive vias each electrically connected to the ground conductor and each electrically coupled to the first patch conductor, the electrically-conductive vias being disposed with angular symmetry about a center of the first patch conductor.

5. The UE antenna system of claim 1, wherein the frequency inhibitor is a second frequency inhibitor, and wherein the UE antenna system further comprises a first frequency inhibitor comprising at least one notch filter, with each of the at least one notch filter being coupled to a respective one of the at least one second energy coupler and configured to suppress frequencies in the first frequency range.

6. The UE antenna system of claim 5, wherein each of the at least one notch filter comprises an open-ended transmission line electrically connected to the respective one of the at least one second energy coupler.

7. The UE antenna system of claim 6, wherein the open-ended transmission line of each of the at least one notch filter has a length of between 0.2 wavelengths, in the dielectric material, of a frequency in the first frequency range and 0.3 wavelengths, in the dielectric material, of the frequency of the first frequency range.

8. The UE antenna system of claim 1, wherein the second frequency range includes a frequency that is twice a frequency of the first frequency range.

9. The UE antenna system of claim 1, wherein the first patch conductor is disposed between the second patch conductor and the ground conductor.

10. The UE antenna system of claim 1, further comprising at least one matching stub each comprising a transmission line electrically connected to a respective one of the at least one first energy coupler and electrically connected to a ground member that is electrically connected to the ground conductor.

11. The UE antenna system of claim 1, wherein the dual-range antenna element is one of a plurality of dual-range antenna elements disposed in a linear array, the UE antenna system further comprising a third antenna element disposed between adjacent ones of the plurality of dual-range antenna elements and configured to transduce signals in the second frequency range.

12. The UE antenna system of claim 1, wherein the dual-range antenna element is one of a plurality of first dual-range antenna elements, the UE antenna system further comprising:
a plurality of second dual-range antenna elements configured to transduce signals in the second frequency range and a third frequency range that includes frequencies higher than the second frequency range; and
a plurality of third antenna elements configured to transduce signals in the third frequency range;
wherein the plurality of first dual-range antenna elements, the plurality of second dual-range antenna elements, and the plurality of third antenna elements are disposed in a linear array;
wherein a pair of the plurality of second dual-range antenna elements and a pair of the plurality of third antenna elements are disposed between each pair of adjacent ones of the plurality of first antenna elements, with the pair of the plurality of second dual-range antenna elements and the pair of the plurality of third antenna elements being interleaved.

13. A method of transducing signals over multiple frequency ranges, the method comprising:
transducing between first wireless signals and first guided signals using a first antenna element, the first wireless signals and the first guided signals being in a first frequency range;
transducing between second wireless signals and second guided signals using a second antenna element, the second wireless signals and the second guided signals being in a second frequency range that includes higher frequencies than the first frequency range; and
inhibiting energy in the second frequency range from propagating, as a second-order mode, in the first antenna element.

14. The method of claim 13, wherein the inhibiting comprises grounding a region within one-tenth of a wavelength, of a frequency in the first frequency range in a dielectric material in which the patch conductor is disposed, of a center of the patch conductor.

15. The method of claim 13, further comprising inhibiting energy in the first frequency range from propagating in the second antenna element by applying a notch filter to an energy coupler of the second antenna element to suppress frequencies in the first frequency range.

16. The method of claim 13, wherein the second frequency range includes a frequency that is twice a frequency of the first frequency range.

17. A user equipment (UE) antenna system comprising:
means for transducing between first wireless signals and first guided signals using a first antenna element, the first wireless signals and the first guided signals being in a first frequency range;
means for transducing between second wireless signals and second guided signals using a second antenna element, the second wireless signals and the second guided signals being in a second frequency range that includes higher frequencies than the first frequency range; and
means for inhibiting energy in the second frequency range from propagating, as a second-order mode, in the first antenna element.

18. The UE of claim 17, wherein the means for inhibiting comprise means for grounding a region within one-tenth of a wavelength, of a frequency in the first frequency range in a dielectric material in which the patch conductor is disposed, of a center of the patch conductor.

19. The UE of claim 17, further comprising means for filtering energy in an energy coupler of the second antenna element to suppress frequencies in the first frequency range.

20. The UE of claim 17, wherein the second frequency range includes a frequency that is twice a frequency of the first frequency range.
